(19) United States
(12) Patent Application Publication
(10) Pub. No.: US 2026/0084742 A1
(43) Pub. Date: Mar. 26, 2026

(54) VEHICLE STEERING APPARATUS, METHOD OF ASSEMBLING THE SAME, AND VEHICLE

(71) Applicant: HL MANDO CORPORATION, Gyeonggi-do (KR)

(72) Inventors: Kyungsub SHIN, Gyeonggi-do (KR); Seunghyun BAE, Gyeonggi-do (KR); Subong LEE, Gyeonggi-do (KR)

(21) Appl. No.: 19/333,327

(22) Filed: Sep. 18, 2025

(30) Foreign Application Priority Data
Sep. 24, 2024 (KR) 10-2024-0129071

(51) Int. Cl. B62D 5/04

(52) U.S. Cl. CPC B62D 5/0445; B62D 5/0421; B62D 5/046; B62D 5/0403

(57) ABSTRACT

A vehicle steering apparatus and a vehicle include a lead screw bar including a nut coupling portion to which a lead nut is coupled, a first coupling portion provided at one end of the nut coupling portion, and a second coupling portion provided at the other end of the nut coupling portion, a first connecting bar having a first connecting hole provided at one end into which the first coupling portion is inserted and coupled, and a second connecting bar having a second connecting hole provided at one end into which the second coupling portion is inserted and coupled.

### CROSS-REFERENCE TO RELATED APPLICATION

This application claims the priority of Korean Patent Application No. 10-2024-0129071 filed on Sep. 24, 2024, in the Korean Intellectual Property Office, the disclosure of which is incorporated herein by reference.

### BACKGROUND

### Field

The present embodiments relate to a vehicle steering apparatus, a method of assembling the same, and a vehicle. More specifically, in a vehicle and a vehicle steering apparatus, the present embodiments relate to a vehicle, a vehicle steering apparatus, and a method of assembling the same, which can satisfy the rigidity of a screw bar while reducing the weight of the screw bar and satisfying the assembly stability with a nut even in a case where the size and weight of the vehicle increase.

### Description of the Related Art

In general, a vehicle steering apparatus is equipped with a hydraulic device, motor, reducer, or the like to steer the wheels of the vehicle according to the driving conditions of the vehicle, and is usually operated in the rear wheels of a typical vehicle or the front and rear wheels of a steer-by-wire system.

In a vehicle steering system, an axial movement of a screw bar is measured by a sensor that detects the movement of a magnet, and the sensor measures the displacement of an object that moves in a linear reciprocating motion, and an electronic control device stably controls the rotation of the vehicle based on the displacement.

However, the conventional vehicle steering apparatus has a problem in that, as the size and weight of vehicles have increased due to the recent transition to hybrid or electric vehicles, the size and weight of the screw bar have also increased in order to increase the rigidity of the screw bar.

In addition, there is a problem that the measurement accuracy of the steering angle is reduced because the change in axial displacement of the screw bar cannot be accurately measured in a case where deformation of the screw bar occurs due to low rigidity of the screw bar.

Accordingly, research is being conducted to reduce the weight of the screw bar while satisfying the rigidity of the screw bar and also to satisfy the assembly stability with the nut, even as the size and weight of the vehicle increase.

### SUMMARY

Accordingly, the present embodiments have been devised in consideration of the background described above, and an object thereof is to provide a vehicle steering apparatus capable of reducing the weight of the screw bar while satisfying the rigidity of the screw bar and satisfying the assembling property with the nut even in a case where the size and weight of the vehicle increase.

In one aspect, the present embodiments may provide a vehicle steering apparatus including: a screw bar including one end portion, another end portion, and a nut coupling portion configured to engageable with a nut and peovided between the one end portion and the another end portion of the screw bar; a first connecting bar having a first connecting hole provided at an end portion of the first connecting bar, wherein the one end portion of the screw bar is disposed in the first connecting hole of the first connecting bar; and a second connecting bar having a second connecting hole provided at an end portion of the second connecting bar, wherein the another end portion of the screw bar is disposed in the second connecting hole of the second connecting bar.

Moreover, in the present embodiments, a screwed portion of an outer surface of the one end portion of the screw bar is engaged with a screwed portion of an inner surface of the first connecting hole of the first connecting bar.

Further, in the present embodiments, an adhesive may be provided between the one end portion of the screw bar and the first connecting hole of the first connecting bar.

In addition, in the present embodiments, an outer peripheral protrusion, which protrudes from an outer surface of the screw bar to support the end portion of the first connecting bar, may be provided between the nut coupling portion and the one end portion of the screw bar.

Additionally, in the present embodiments, in outer peripheral protrusion of the screw bar has a side surface supporting the end portion of the first connecting bar and protrudes in a direction perpendicular to the first connecting bar.

Moreover, in the present embodiments, the screw bar has a first groove portion recessed from the outer surface of the screw bar between the one end portion and the outer peripheral protrusion of the screw bar.

Further, in the present embodiments, an inner surface of the first connecting hole has a ring-shaped inner peripheral groove positioned adjacent to the end portion of the first connecting bar.

In addition, in the present embodiments, the outer peripheral protrusion of the screw bar has a ring shape.

Additionally, in the present embodiments, the outer peripheral protrusion of the screw bar has a ring shape with a cut surface on an outer peripheral surface of the outer peripheral protrusion.

Furthermore, in the present embodiments, the second connecting bar may include an outer connecting hole having a diameter larger than the second connecting hole and located at the end portion of the second connecting bar.

Moreover, in the present embodiments, the vehicle steering apparatus may further include with a screwed portion of an outer surface of the another end portion of the screw bar is engaged with a screwed portion of an inner surface of the second connecting hole of the second connecting bar.

In addition, in the present embodiments, the screw bar comprises a press-fitting portion press-fitted in the inner surface of the outer connecting hole of the connecting bar and provided between the nut coupling portion and the another end portion of the screwed bar.

Additionally, another end portion of the first connecting bar includes a first jig assembly portion having a recessed shape.

Moreover, in the present embodiments, another end portion of the second connecting bar includes a second jig assembly portion having a recessed shape.

In one aspect, the present embodiments may provide a method for assembling a vehicle steering apparatus, the method including: aligning one end of a screw bar and one end of a first connecting bar; coupling a jig or tool to a first jig assembly portion formed at another end of the first connecting bar; screw-coupling the first connecting bar to the screw bar until the one end of the first connecting bar contacts an outer peripheral protrusion protruding from an outer surface of the screw bar; screw-coupling another end of the screw bar to one end of a second connecting bar.

In addition, in the present embodiments, the method for assembling a vehicle steering apparatus may further comprises applying an adhesive to an outer surface of the one end of the screw bar and an inner surface of the one end of the first connecting bar.

Furthermore, in the present embodiments, the method for assembling a vehicle steering apparatus may further comprises coupling the jig or tool to a second jig assembly portion formed on another end of the second connecting bar to screw-couple the second connecting bar to the screw bar.

Moreover, in the present embodiments, the method for assembling a vehicle steering apparatus may further comprises a press-fitting portion formed on the another end of the screw bar into an outer connecting hole formed on the another end of the second connecting bar.

In one aspect, the present embodiments may provide a vehicle including: a slidable rod including a screw bar having one end portion, another end portion, and a nut coupling portion configured to be engageable with, and provided between the one end portion and the another end portion of the screw bar, a first connecting bar having a first connecting hole provided at an end portion of the first connecting bar, wherein the one end portion of the screw bar is disposed in the first connecting hole of the first connecting bar, and a second connecting bar having a second connecting hole provided at an end portion of the second connecting bar, wherein the another end portion of the screw bar is disposed in the second connecting hole of the second connecting bar; a nut pulley coupled to the nut; a rod housing accommodating the nut pulley and the slidable rod; a drive member coupled to the rod housing and configured to rotate the nut pulley; a position sensor configured to detect displacement of the slidable rod; and a controller configured to receive information transmitted from the position sensor and transmits a control signal for controlling the drive member.

Additionally, in the present embodiments, the drive member may include a motor driven by the control signal of the controller, a motor pulley coupled to the motor, and a drive belt connecting the motor pulley and the nut pulley.

According to the above-described embodiments, it is possible to provide a vehicle steering apparatus, a method of assembling the same, and a vehicle, which can satisfy the rigidity of the screw bar while reducing the weight of the screw bar and satisfying the assembly stability with the nut even in a case where the size and weight of the vehicle increase.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1 and 2 are perspective views illustrating a part of a vehicle steering apparatus according to the present embodiments;

FIGS. 3 to 5 are exploded perspective views illustrating a part of the vehicle steering apparatus according to the present embodiments;

FIG. 6 is a cross-sectional view of FIG. 2;

FIGS. 7 and 8 are cross-sectional views illustrating a part of the vehicle steering apparatus according to the present embodiments; and

FIG. 9 is a schematic view illustrating a part of a vehicle according to the present embodiments.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc. but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap,” etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompass all the meanings of the term “can”.

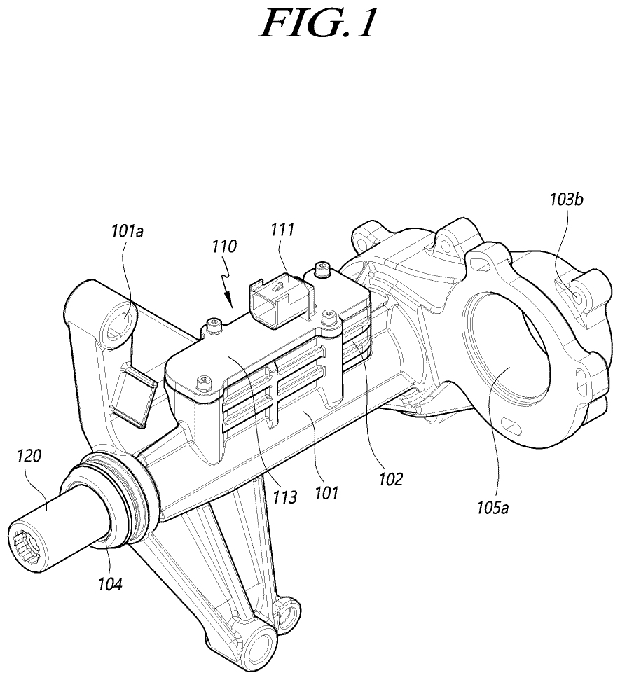

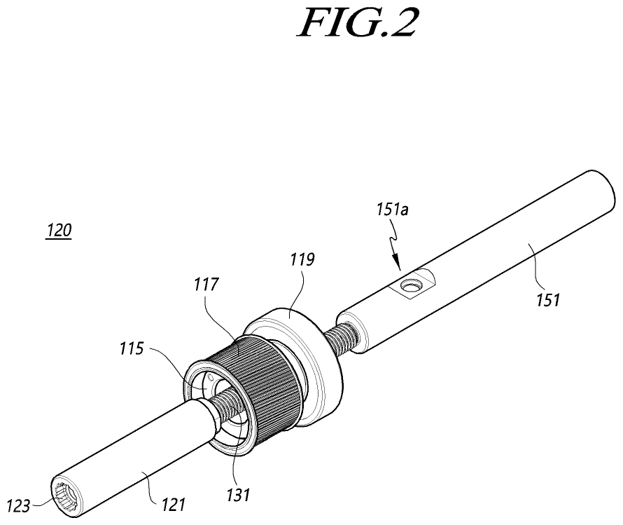

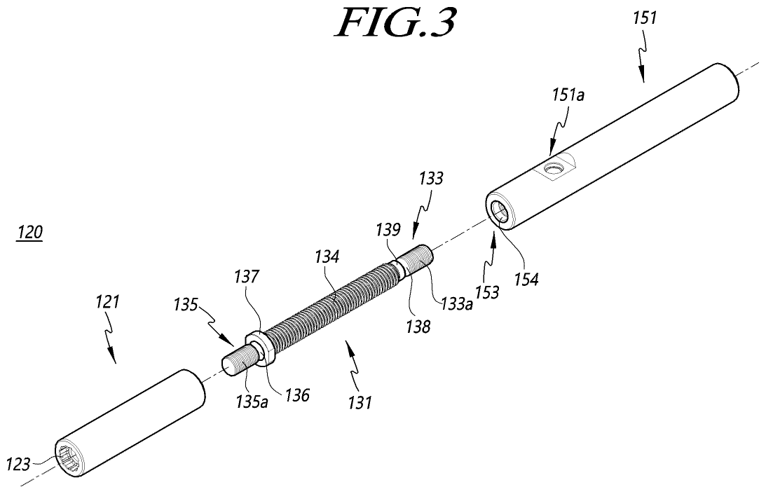

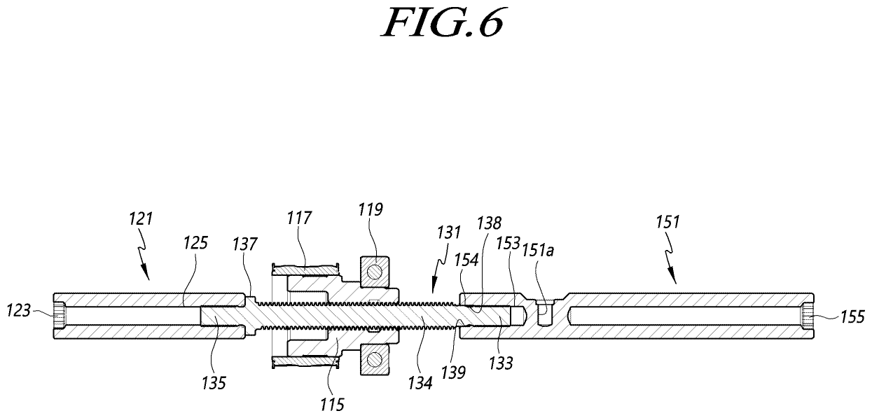

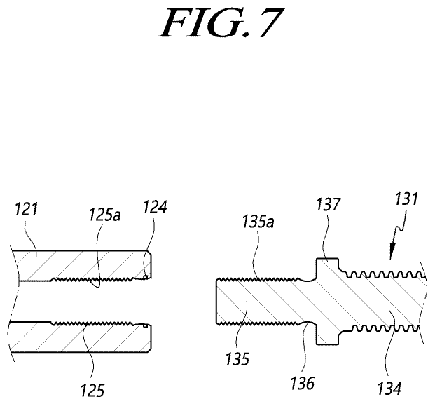

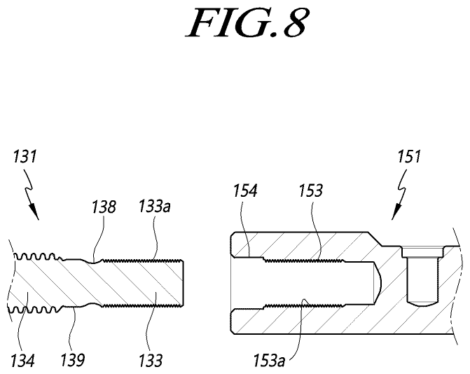

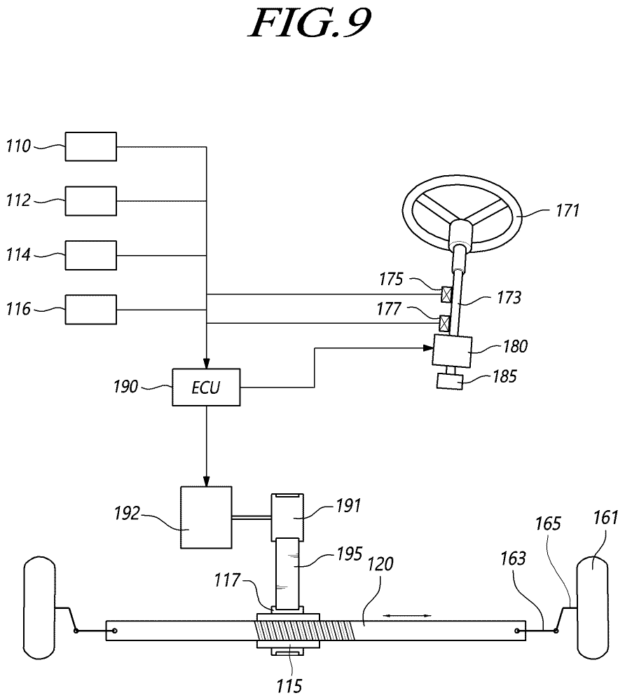

FIGS. 1 and 2 are perspective views illustrating a part of a vehicle steering apparatus according to the present embodiments, FIGS. 3 to 5 are exploded perspective views illustrating a part of the vehicle steering apparatus according to the present embodiments, FIG. 6 is a cross-sectional view of FIG. 2, FIGS. 7 and 8 are cross-sectional views illustrating a part of the vehicle steering apparatus according to the present embodiments, and FIG. 9 is a schematic view illustrating a part of a vehicle according to the present embodiments. As illustrated in these drawings, the vehicle steering apparatus according to the present embodiments includes a screw bar 131 including one end portion 135, another end portion 133, and a nut coupling portion 134 configured to be engageable with a nut 115 and provided between the one end portion and another end portion of the screw bar 131, a first connecting bar 121 having a first connecting hole 125 provided at an end portion of the first connecting bar, wherein the one end portion 135 of the screw bar 131 is disposed in the first connecting hole of the first connecting bar 151, and a second connecting bar 151 having a second connecting hole 153 provided at an end portion of the second connecting bar 151, wherein the another end portion 133 of the screw bar 131 is disposed in the second connecting hole 153 of the second connecting bar 151.

The screw bar 131 is provided with the nut coupling portion 134 that is coupled with the nut 115 in the central portion, and the one end portion 135 is provided at one end of the nut coupling portion 134 and the another end portion 133 is provided at the other end of the nut coupling portion 134.

The first connecting bar 121 has the first connecting hole 125 in which the one end portion 135 of the screw bar 131 is inserted into and connected to one end thereof, and the second connecting bar 151 has a second connecting hole 153 in which the another end portion 133 of the screw bar 131 is inserted into and connected to one end thereof.

These first connecting bar 121, screw bar 131, and second connecting bar 151 are axially connected to each other to form a sliding rod 120, which is built into the rod housing 101 and performs steering of the vehicle while performing a linear sliding motion in the axial direction.

Moreover, through the fastening hole 151a formed in the second connecting bar 151, a position sensor 110 detects the change in the magnetic field of a magnet (not illustrated) that slides linearly together with the second connecting bar 151 and transmits the change in the axial displacement of the sliding rod 120 to the electronic control device to determine the steering angle.

The rod housing 101 is provided with a body fixing hole 101a for fixing to the body of a vehicle.

The position sensor 110 is provided above the rod housing 101 and is connected to a housing cover 113 as a fastening member, and a connector terminal 111 for connection to a power source and electronic control device is provided on the housing cover 113.

In addition, a through hole 104 through which a sliding rod 120 slides is provided at the lower portion of the rod housing 101, and a drive portion fastener 103b on which a drive portion including the nut 115, a bearing, a nut pulley, a motor, or the like is mounted, and a motor mounting hole 105a on which the motor is mounted is provided at one side of the rod housing 101, and detailed descriptions of the components of the drive portion will be omitted.

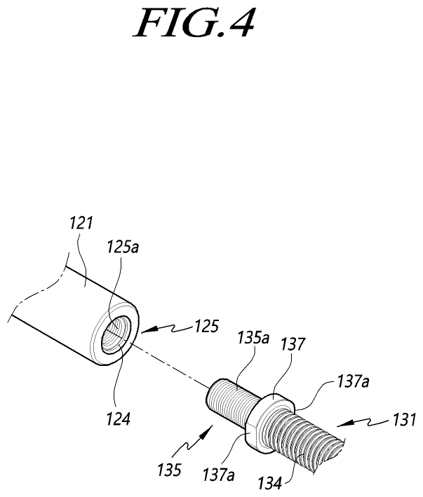

As illustrated in FIGS. 3 and 4, the outer surface of the one end portion 135 and the inner surface of the first connecting hole 125 are provided with screwed portions 135a and 125a that engage with each other, so that the screw bar 131 and the first connecting bar 121 can be screw-coupled.

Moreover, in a case of screwing the screw bar 131 and the first connecting bar 121, an adhesive is applied to the screwed portion 135a and 125a so that the one end portion 135 and the first connecting hole 125 can be engaged with the adhesive.

Accordingly, the screw bar 131 and the first connecting bar 121 are screw-coupled and then prevented from loosening by the adhesive.

An outer peripheral protrusion 137 which protrudes from the outer peripheral surface and by which the end portion of the first connecting bar 121 is supported may be provided between the nut coupling portion 134 and the first joint 135.

Accordingly, the end portion of the first connecting bar 121 is supported by the outer peripheral protrusion 137, and the coupling is maintained by the screw tightening force, preventing loosening.

That is, in a case of screw-coupling the screw bar 131 and the first connecting bar 121, the screw-coupling is performed so that the fastening force of the tool is adjusted to the force for supporting the end portion of the first connecting bar 121 by the outer peripheral protrusion 137, thereby controlling the fastening force and loosening force of the screw bar 131 and the first connecting bar 121.

The outer peripheral protrusion 137 may be formed as a plane whose side surface by which the end portion of the first connecting bar 121 is supported is perpendicular to the outer peripheral surface of the first connecting bar 121, and the end portion of the first connecting bar 121 may be formed as a plane parallel to the side surface of the outer peripheral protrusion 137.

Accordingly, in a case where the screw bar 131 and the first connecting bar 121 are screw-coupled, the end portion of the first connecting bar 121 is supported by the outer peripheral protrusion 137 by the set fastening force of the tool, and in a case where the rotation stops, the central axes of the first connecting bar 121 and the screw bar 131 can be maintained on the same axis.

In addition, a first groove portion 136 formed to be recessed from the outer surface of the one end portion 135 may be provided between the one end portion 135 and the outer peripheral protrusion 137, and the first groove portion 136 may be formed as a concave curved surface on the outer surface.

Due to this first groove portion 136, it is possible to accommodate manufacturing errors or assembly errors in the first connecting hole 125 formed in the first connecting bar 121.

That is, in a case where a manufacturing error or assembly error occurs in the first connecting hole 125 without the first groove portion 136, deformation may occur at the entrance of the first connecting hole 125 during assembly, and as a result, cases may occur where the screw bar 131 and the first connecting bar 121 are not maintained in a coaxial state in a case where the coupling therebetween is completed.

However, in a case where the first groove portion 136 is provided, the deformation of the entrance portion of the first connecting hole 125 is accommodated by the space of the first groove portion 136, so that the central axes of the first connecting bar 121 and the screw bar 131 can be maintained coaxially.

In addition, the first connecting hole 125 may be provided with a ring-shaped inner peripheral groove 124 on the inner surface adjacent to the end supported by the outer peripheral protrusion 137.

In the inner peripheral groove 124, in the case where a manufacturing error or assembly error occurs in the first connecting hole 125, the deformation of the entrance of the first connecting hole 125 is accommodated by the space of the inner peripheral groove 124, thereby allowing the central axes of the first connecting bar 121 and the screw bar 131 to be maintained coaxially.

The outer peripheral protrusion 137 may be formed to protrude in a ring shape and may have a cut surface 137a provided on the outer peripheral surface.

Additionally, the cut surface 137a may be provided as a plane facing each other on the outer peripheral surface of the outer peripheral protrusion 137.

Accordingly, in a case of screw-coupling the first connecting bar 121 and the screw bar 131, a tool can be attached to the cut surface 137a of the outer peripheral protrusion 137, making assembly easier.

Meanwhile, referring to FIGS. 3 to 8, the second connecting bar 151 may be formed with an enlarged diameter at the end of the second connecting hole 153 and may be provided with an outer connecting hole 154 disposed at the end portion of the second connecting bar 151.

In addition, screwed portions 133a and 153a that engages with the outer surface of the another end portion 133 and the inner surface of the second connecting hole 153 may be provided.

Accordingly, the screw bar 131 and the second connecting bar 151 may be screw-coupled.

An adhesive is applied to the screwed portions 133a and 153a so that the another end portion 133 and the second connecting hole 153 can be engaged.

Accordingly, the screw bar 131 and the second connecting bar 151 are prevented from loosening by the adhesive after being screw-coupled together.

A press-fitting portion 139 that is press-fitted into the inner surface of the outer connecting hole 154 may be provided between the nut coupling portion 134 and the second joint portion 133.

Accordingly, in a case where the screw bar 131 and the second connecting bar 151 are screw-coupled, the press-fitting portion 139 is press-fitted, so that even in a case where the manufacturing error or assembly error occurs in the screwed portions 133a and 153a, the central axes of the screw bar 131 and the second connecting bar 151 can be maintained on the same axis.

That is, even in a case where deformation of the screwed portions 133a and 153a occurs due to the manufacturing error or assembly error of the screwed portions 133a and 153a, the screw-coupling is achieved while maintaining the same axis since the press-fitting portion 139 of the screw bar 131 is press-fitted into the outer connecting hole 154.

In addition, an outer peripheral groove 138 formed to be recessed in the outer surface of the press-fitting portion 139 may be provided between the press-fitting portion 139 and the another end portion 133, and the outer peripheral groove 138 may be formed as a concave curved surface on the outer surface.

In a case where the manufacturing or assembly error occurs in the press-fitting portion 139 and the outer connecting hole 154, the deformation of the press-fitting portion 139 and the outer connecting hole 154 is accommodated into the space of the outer groove 138, thereby allowing the central axes of the screw bar 131 and the second connecting bar 151 to be maintained coaxially.

In addition, another end portion of the first connecting bar 121 includes a first jig assembly portion 123 formed in a recessed shape may be provided at the other end of the first connecting bar 121, and another end portion of the second connecting bar 151 includes a second jig assembly portion 155 formed in a recessed shape may be provided at the other end of the second connecting bar 151.

Accordingly, a jig or tool is coupled to the first jig assembly portion 123 of the first connecting bar 121 and the second jig assembly portion 155 of the second connecting bar 151, and the screw bar 131 is assembled, so that the screw-coupling is formed while maintaining the same axis, and also, damage to the outer surfaces of the first connecting bar 121 and the second connecting bar 151 can be prevented during assembly.

Additionally, the first connecting bar 121 may be formed as a hollow body with first connecting holes 125 provided on both sides in the axial direction.

That is, the first connecting hole 125 may be formed through one end and the other end of the first connecting bar 121, thereby reducing weight and material costs.

In addition, the second connecting bar 151 may be formed with the other end being hollow. That is, the second connecting hole 153 may be formed at one end based on the fastening hole 151a and the other end may be formed hollow, thereby reducing weight and material costs.

The method of assembling a vehicle steering apparatus as described above includes aligning one end of the screw bar 131 and one end of a first connecting bar 121, coupling a jig or tool to the first jig assembly portion 123 formed on the other end of the first connecting bar 121, screw-coupling the first connecting bar 121 until a force for supporting the one end of the first connecting bar 121 by the outer peripheral protrusion 137 formed on the outer peripheral side of the screw bar 131 reaches a set fastening force, and screw-coupling the other end of the screw bar 131 to one end of the second connecting bar 151.

That is, as illustrated in FIGS. 3 and 4, one end of the screw bar 131 and one end of the first connecting bar 121 are aligned coaxially, and the one end portion 135 is screw-coupled to the first connecting hole 125.

In the screw-coupling of the first connecting bar 121, an adhesive may be applied to the outer surface of one end of the screw bar 131, that is, the outer surface of the one end portion 135, and the inner surface of one end of the first connecting bar 121, that is, the inner surface of the first connecting hole 125, and the first connecting bar 121 may be screw-coupled.

Then, a jig or tool is coupled to the first jig assembly portion 123 formed in a recessed shape on the other end of the first connecting bar 121 to rotate the first connecting bar 121, and thus, the first connecting bar 121 is screw-coupled.

The screw-coupling of the first connecting bar 121 is performed until a force for supporting the one end of the first connecting bar 121 by the outer peripheral protrusion 137 formed on an outer peripheral side of the screw bar 131 reaches a set fastening force, and while the end portion of the first connecting bar 121 is supported by the outer peripheral protrusion 137, the coupling is maintained by the screw tightening force, thereby preventing loosening.

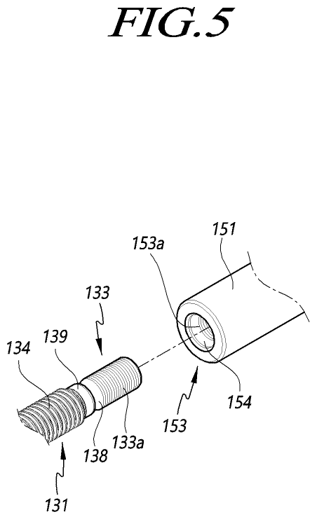

In the screw-coupling of the second connecting bar 151, as illustrated in FIGS. 3 and 5, a jig or tool is coupled to the second jig assembly portion 155 formed on the other end of the second connecting bar 151 and the second connecting bar 151 is rotated and screw-coupled.

In addition, in the screw-coupling of the second connecting bar 151, the press-fitting portion 139 formed on the other end of the screw bar 131 is press-fitted into the outer connecting hole 154 formed on the other end of the second connecting bar 151 and screwed-coupled.

Accordingly, the press-fitting portion 139 is press-fitted while the screw bar 131 and the second connecting bar 151 are screw-coupled, so that even in a case where a manufacturing error or assembly error occurs in the screwed portions 133a and 153a, the central axes of the screw bar 131 and the second connecting bar 151 can be maintained on the same axis.

Meanwhile, referring to FIGS. 1 to 8 together with FIG. 9, a vehicle according to the present embodiments includes the sliding rod 120 including the screw bar 131 having the nut coupling portion 134 to which the nut 115 is coupled, the one end portion 135 provided at one end of the nut coupling portion 134, and the another end portion 133 provided at the other end of the nut coupling portion 134, the first connecting bar 121 having the first connecting hole 125 provided at one end into which the one end portion 135 is inserted and coupled, and the second connecting bar 151 having the second connecting hole 153 provided at one end into which the another end portion 133 is inserted and coupled, the nut pulley 117 coupled to the outer periphery of the nut 115, the rod housing 101 (refer to FIG. 1) in which the nut pulley 117 and the sliding rod 120 are built, drive members 191, 192, 195, and 117 coupled to the rod housing and rotating the nut pulley 117, the position sensor 110 (refer to FIG. 1) which detects and transmits an axial displacement of the sliding rod 120, and an electronic control device 190 which receives information transmitted from the position sensor and transmits a control signal to the drive member.

Here, the sliding load 120 is the same as described above, so the detailed descriptions thereof are omitted.

As illustrated in FIG. 9, an angle sensor 175 and a torque sensor 177 are coupled to one side of a steering shaft 173 connected to a steering wheel 171, and in a case where the driver operates the steering wheel 171, the angle sensor 175 and the torque sensor 177 detect the operation of the driver and send an electric signal to the electronic control device 190 so that a steering shaft motor 180 and a motor 192 of the drive member are operated.

The electronic control device 190 controls the steering shaft motor 180 and the motor 192 of the drive member based on electric signals transmitted from the angle sensor 175 and the torque sensor 177 and electric signals transmitted from various sensors mounted on the vehicle.

The steering shaft motor 180 is connected to a reducer that reduces the rotational speed of the motor, and during normal driving, a reaction force is provided to the steering shaft 173 so that the driver can feel a steering reaction force in the opposite direction in a case where the driver operates the steering wheel 171, and during autonomous driving, the steering is performed by the control of the electronic control device 190 without the intervention of the driver's will.

The motor 192 of the drive member slides the sliding rod 120 through the belt 195 and the nut 115 to steer the wheels 161 on both sides through the tie rod 163 and the knuckle arm 165.

The drive member includes the nut pulley 117 coupled to the nut 115, the motor pulley 191 coupled to the motor 192 and connected to the nut pulley 117 by the drive belt 195, and the drive belt 195 connecting the motor pulley 191 and the nut pulley 117, and in a case where the nut pulley 117 rotates, the sliding rod 120 slides in the axial direction.

In the drawings of the present embodiments, for convenience of explanation, for example, it is described that the angle sensor 175 and the torque sensor 177 provided in the steering shaft 173, and the vehicle speed sensor 112, the position sensor 110, the ultrasonic sensor 114, and the image sensor 116 for transmitting steering information to the electronic control device 190 are provided. However, in addition, a motor position sensor, various types of radars and lidars, and the like may be provided, and detailed descriptions thereof will be omitted below.

According to these embodiments, in the vehicle steering apparatus, it is possible to satisfy the rigidity of a screw bar while reducing the weight of the screw bar and satisfying the assembly stability with the nut even in a case where the size and weight of the vehicle increase.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A vehicle steering apparatus comprising:
a screw bar including one end portion, another end portion, and a nut coupling portion configured to be engageable with a nut and provided between the one end portion and the another end portion of the screw bar;
a first connecting bar having a first connecting hole provided at an end portion of the first connecting bar, wherein the one end portion of the screw bar is disposed in the first connecting hole of the first connecting bar; and
a second connecting bar having a second connecting hole provided at an end portion of the second connecting bar, wherein the another end portion of the screw bar is disposed in the second connecting hole of the second connecting bar.

2. The vehicle steering apparatus of claim 1, wherein a screwed portion of an outer surface of the one end portion of the screw bar is engaged with a screwed portion of an inner surface of the first connecting hole of the first connecting bar.

3. The vehicle steering apparatus of claim 2, wherein an adhesive is provided between the one end portion of the screw bar and the first connecting hole of the first connecting bar.

4. The vehicle steering apparatus of claim 2, wherein an outer peripheral protrusion, which protrudes from an outer surface of the screw bar to support the end portion of the first connecting bar, is provided between the nut coupling portion and the one end portion of the screw bar.

5. The vehicle steering apparatus of claim 4, wherein the outer peripheral protrusion of the screw bar has a side surface supporting the end portion of the first connecting bar and protrudes in a direction perpendicular to the first connecting bar.

6. The vehicle steering apparatus of claim 4, wherein the screw bar has a first groove portion recessed from the outer surface of the screw bar between the one end portion and the outer peripheral protrusion of the screw bar.

7. The vehicle steering apparatus of claim 4, wherein an inner surface of the first connecting hole has a ring-shaped inner peripheral groove positioned adjacent to the end portion first connecting bar.

8. The vehicle steering apparatus of claim 4, wherein the outer peripheral protrusion of the screw bar has a ring shape.

9. The vehicle steering apparatus of claim 4, wherein the outer peripheral protrusion of the screw bar has a ring shape with a cut surface on an outer peripheral surface of the outer peripheral protrusion.

10. The vehicle steering apparatus of claim 1, wherein the second connecting bar includes an outer connecting hole having a diameter larger than the second connecting hole and located at the end portion of the second connecting bar.

11. The vehicle steering apparatus of claim 10, a screwed portion of an outer surface of the another end portion of the screw bar is engaged with a screwed portion of an inner surface of the second connecting hole of the second connecting bar.

12. The vehicle steering apparatus of claim 10, wherein the screw bar comprises a press-fitting portion press-fitted in the inner surface of the outer connecting hole of the connecting bar and provided between the nut coupling portion and the another end portion of the screw bar.

13. The vehicle steering apparatus of claim 1, wherein another end portion of the first connecting bar includes a first jig assembly portion having a recessed shape.

14. The vehicle steering apparatus of claim 1, wherein another end portion of the second connecting bar includes a second jig assembly portion having a recessed shape.

15. A method for assembling a vehicle steering apparatus, the method comprising:
aligning one end of a screw bar and one end of a first connecting bar;
coupling a jig or tool to a first jig assembly portion formed at another end of the first connecting bar;
screw-coupling the first connecting bar to the screw bar until the one end of the first connecting bar contacts an outer peripheral protrusion protruding from an outer surface of the screw bar; and
screw-coupling another end of the screw bar to one end of a second connecting bar.

16. The method of claim 15, further comprising applying an adhesive to an outer surface of the one end of the screw bar and an inner surface of the one end of the first connecting bar.

17. The method of claim 15, further comprising coupling the jig or tool to a second jig assembly portion formed on another end of the second connecting bar to screw-couple the second connecting bar to the screw bar.

18. The method of claim 17, further comprising press-fitting a press-fitting portion formed on the another end of the screw bar into an outer connecting hole formed on the another end of the second connecting bar.

19. A vehicle comprising:
a slidable rod including a screw bar having one end portion, another end portion, and a nut coupling portion configured to be engageable with a nut and provided between the one end portion and the another end portion of the screw bar, a first connecting bar having a first connecting hole provided at an end portion of the first connecting bar, wherein the one end portion of the screw bar is disposed in the first connecting hole of the first connecting bar, and a second connecting bar having a second connecting hole provided at an end portion of the second connecting bar, wherein the another end portion of the screw bar is disposed in the second connecting hole of the second connecting bar;
a nut pulley coupled to the nut;
a rod housing accommodating the nut pulley and the slidable rod;
a drive member coupled to the rod housing and configured to rotate the nut pulley;
a position sensor configured to detect displacement of the slidable rod; and
a controller configured to receive information transmitted from the position sensor and transmit a control signal for controlling the drive member.

20. The vehicle of claim 19, wherein the drive member includes:
a motor driven by the control signal of the controller,
a motor pulley coupled to the motor, and
a drive belt connecting the motor pulley and the nut pulley.
